(19) United States
(12) Patent Application Publication
(10) Pub. No.: US 2018/0156435 A1
(43) Pub. Date: Jun. 7, 2018

(54) FUNCTIONALITY LED ASSEMBLY- LINKED DISPLAYING DEVICE

(71) Applicant: COCOON DESIGN CO., LTD., Gwangmyeong-si (KR)

(72) Inventor: Youngjun Kwon, Seoul (KR)

(21) Appl. No.: 15/653,670

(22) Filed: Jul. 19, 2017

(30) Foreign Application Priority Data
Dec. 5, 2016 (KR) 10-2016-0164358

(51) Int. Cl. F21V 23/06; F21V 14/04; F21V 31/00; F21V 23/00; F21V 7/05

(52) U.S. Cl. CPC F21V 23/06; F21V 14/04; F21Y 2115/10; F21V 23/002; F21V 7/05; F21V 31/005

(57) ABSTRACT

A displaying device includes: a side wall having six sides and at least one first locking groove; a main body having a disposition unit bent from a side wall with first fixing grooves; a core side wall having a second locking groove disposed facing the first locking groove. The core side wall has sides inserted closely into the core side wall; a core body having a lower side bent from the core side wall and a core including an LED lamp; a cover having cover side covering top of the main body, a light from the LED lamp penetrates the cover side; an LED assembly having a base coupled by a fastener connecting the second fixing groove facing the first fixing groove and supporting the lower part of the main body; and a connector penetrating the first and second locking grooves and inserted in the core body through the LED assembly.

### REFERENCE TO RELATED APPLICATIONS

This application claims the priority benefit of Korean Patent Application No. 10-2016-0164358 filed on Dec. 5, 2016, the entire contents of which are incorporated herein by reference.

### FIELD OF THE INVENTION

The present disclosure relates to a displaying device using functionality LED assembly, more specifically to a LED lighting device which provides not only lighting function but various displaying effects, wherein the displaying device can show various shapes of assembly/connection structure according to a plurality of LED assemblies of hexagonal pillar with LED lamps connected to flexible connectors.

### BACKGROUND OF THE INVENTION

An LED, which is generally used for lighting nowadays, has lighting application technology with development of technology on its own structure, efficiency and radiation.

That is, development of LED technology is focused on various conveniences such as great radiation subject to relatively small size and parallel feature of light, such that a lighting device can be specialized in various structures and functions.

More particularly, an LED provides not only its basic function such as lighting but also various visual effects and decoration.

In other words, by color-changing function and change of module/structure of device which accommodates LED, the LED can provide lighting effect for stage, decoration, various visual effects and aesthetic function with a plurality of open technologies.

For example, Korean Patent Application Publication No. 942516 “Decorative tiles LED block” describes an LED block which may include; an upper case having a plurality of fastening portions formed with a predetermined interval between the plurality of light transmitting portions and disposed at equal intervals on the four corners of the upper surface, wherein the light transmission portion is protruded; a lower case fastened with the upper case in the lower part of the upper case; printed circuit board including a plurality of LEDs disposed at the upper portion thereof and a circuit for driving the plurality of LEDs are disposed at positions corresponding to the plurality of light transmitting portions at the lower part thereof; a sealing unit for performing a waterproof function and disposed between the upper case and the lower case; and LED block including a plurality of tiles, wherein a tile coupling portion formed in the lower fastening is coupled with the coupling portion of the upper case and has a tile light transmission unit corresponding to the light transmitting portions. However, the related art mentioned above results in limitation, wherein an embodiment of the related art cannot be attached on a surface of a curvy or steric object due to its plane structure.

Korean Patent Application Publication No. 908634 “Ceiling lamp having decorative sub lighting comprising led and crystal reflector” describes an example of a highly effective ceiling light which may include; an space accommodating unit at the center of a ceiling lamp, a lower part reflective portion and side reflective portion having highly glossy surfaces are respectively disposed at the space accommodating unit; by fixing successively arranged crystal decoration object and LED at the space accommodating unit, the center of the light lamp can provide multi-colored partial decoration light regardless of the original milky white light color of the ceiling lamp. Thus, the partial decoration light can provide aesthetic decoration feature and also differentiation of the color of the partial light by means of multi-color light emitting LED, enhancing the decoration feature. When other lights are turned off and only the LED is turned on, the LED also functions as mood light through various partial lights, providing highly efficient ceiling lamp with not only excellent decoration feature and aesthetic sense but also the basic function of interior lighting as well as mood light. However, although the constitution according to the related art also provides a decoration by using LED, the structure and use are limited to light lamp directly attached to the ceiling, thus it is inapplicable to various objects.

Thus, an LED lighting device is needed for curvy or steric structure of objects to provide not only lighting but also decoration with simple installment.

### SUMMARY OF THE INVENTION

The present disclosure is intended to provide a lighting device by means of a plurality of LED assemblies coupled with flexible connectors, such that easily attached to various objects having curvy or steric structure.

Moreover, the present disclosure is intended to provide convenience by constituting of detachable structure of LED assembly for easy installment and maintenance.

Furthermore, the present disclosure is intended to provide convenient coupling with lighting object by means of a core accommodating LED lamp in LED assembly.

Additionally, the present disclosure is intended to provide means to control a plurality of reflective sides and heights or inclinations thereof to promote various visual effects of LED lamp.

In addition, the present disclosure is to provide automatic control means including light sensor to generate intended intensity of light or effect.

To accomplish those functions described above, an embodiment of a functionality LED assembly-linked displaying device according to the present invention may include; a side wall having six sides and at least one first locking groove; a main body having a fixing unit bent toward outside from a side wall with a plurality of first fixing grooves; a core side wall having a second locking groove disposed in the opposite side of the first locking groove, wherein the core side wall has sides which are in close contact and to be inserted into the core side wall; a core body having lower part side bent from the core side wall and a core including a plurality of LED lamps; a cover having cover side, in which the light from the LED lamp penetrates the cover side while the cover side is covering the top side of the main body; a LED assembly having a base coupled by a fastener connecting the second fixing groove in the opposite side of the first fixing groove and supporting the lower part of the main body while the core body is inserted in the main body; and a connector which penetrates the first and the second locking grooves and is inserted in the core body through the LED assembly, made of a material having even thickness.

Moreover, the device may further include a water proof connector cover which covers the connector on a surface thereof and a rubber packing of the inside of the main body in close contact along an inner peripheral to seal the first locking groove from water and dust.

Furthermore, the base may include a main slot which is recessed and inserted to cross the center of a pair of sides, and an auxiliary slot which is recessed and inserted in doubled depth of the main slot to cross the center of rest of sides respectively disposed in the left and right direction of the main slot. And the displaying device includes a wire made of a material having even thickness and flexibility to penetrate at least one of the main slot and auxiliary slot and to be inserted, such that connects the base and a plurality of LED assemblies.

Additionally, Inside of the main body, includes a reflective plate having a space from the core body to cover the core body and reflecting lights generated from the LED lamp.

Moreover, at the center part of the core body, a core pillar is extended toward height direction. The reflective plate is divided into six identical reflective sides subject to the side wall. On a side of the core pillar, an elevation groove is disposed, wherein one end of the reflective side is inserted in the core pillar, such that the reflective plate is to be moved within predetermined range.

Furthermore, between a reflective side and an adjacent side of the reflective side, an extended block unit is disposed on both sides of reflective plate respectively when half folded, such that the sides can contract and relax from side to side.

Additionally, the core pillar may include; a lamp having at least one LED lamp; a core supporter having a plurality of elevation grooves on a side and supporting the lamp; a coupling unit coupled with the core body disposed on an end of core supporter; and a band-shaped fixing band which fixes outside peripheral of successive layer of the lamp, the core supporter and the coupling, wherein the fixing band having a band groove disposed at the corresponding site of the elevation groove, such that one end of the reflective plate can penetrate the band groove and be inserted into the elevation groove.

Moreover, on the back side of the reflective plate, an elevation projection is protrusively extended to one side of the core body, wherein the connector penetrates through the first locking groove and the second locking groove, such that the connector raise the reflective plate as much as the thickness of the connector.

Additionally, the connector may include; a rotary shaft; a shaft cover which is inserted in the rotary shaft and rotates; at least one rotary projection which is protruded on a surface of the shaft cover; and at least one of the connector including a rotary module which is inserted to the rotary shaft and provides power to rotate the shaft cover.

Furthermore, on a side of the reflective plate, a tooth plate is mounted, in which the tooth plate has teeth which are spaced at uniform intervals and protruded, wherein the tooth plate is vertically bent from the reflective plate. On a side of the core pillar, a supporter is extended to the tooth plate, and a spherical gear is connected to be rotated at one end of the supporter and transmits the rotary power generated according to the raising and lowering movement of the tooth plate between the tooth plate and the other tooth plated disposed on the opposite side, wherein the tooth plate is to be raised and lowered accordingly with other tooth plate disposed on a side of other reflective plate through the spherical gear.

Lastly, the core pillar may include; a light sensor which measures an intensity of light reflected from the LED lamp of the six reflective plates; a controller having an elevation control of the reflective side by operating the rotary module according to the measured intensity of light; and a general control unit which conducts flashing control of pattern and intensity of light according to whether or not the LED lamp is on.

An example of a functionality LED assembly-linked displaying device according to the present invention may provide;

1) convenience to be attached on objects having curvy or various steric structures, wherein the device has a plurality of LED assemblies which configures curvy structure with flexible connectors;

2) convenience with maintenance, due to the detachable coupling structure between the cover and the main body of the LED assemblies;

3) various lighting effects through a reflective plate including reflective sides, wherein the direction of each reflective side can be controlled;

4) manual/automatic control of height by linking the reflective sides with a specific connector surface; and

5) delicate control of direction or angle of reflective sides to accomplish target light intensity or effect by a light sensor included inside of the device.

### BRIEF DESCRIPTION OF THE DRAWINGS

FIG. 1 describes a perspective view of a lighting device according to an embodiment of the present invention.

FIG. 2 describes an exploded perspective view of a lighting device according to an embodiment of the present invention.

FIG. 3 is an illustration showing an example of a lighting device according to an embodiment of the present disclosure.

FIG. 4 illustrates an example of an LED assembly, and FIGS. 4A and 4B illustrate a reflective plate disposed inside of the LED assembly.

FIG. 5 is a side view illustrating a core configuration according to an embodiment of the present disclosure.

FIGS. 6A-6C are end views describing an elevation projection disposed on a reflective side according to an embodiment of the present disclosure.

FIG. 7 is a perspective view describing the connector structure according to an embodiment of present disclosure.

FIG. 8 is a perspective view illustrating configuration of tooth plate on the reflective side according to an embodiment of the present disclosure.

### DETAILED DESCRIPTION OF THE INVENTION

Hereinafter with reference to the attached drawings will be described a preferred embodiment of the present invention; Drawings are not corresponding to the actual reduction to practice of the invention, and each reference numeral of each figure refers to the same element of the figure.

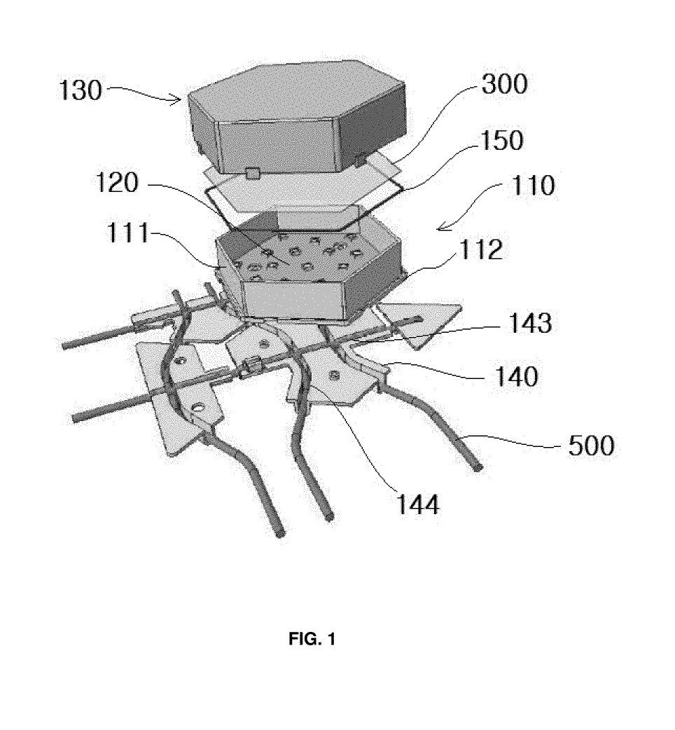

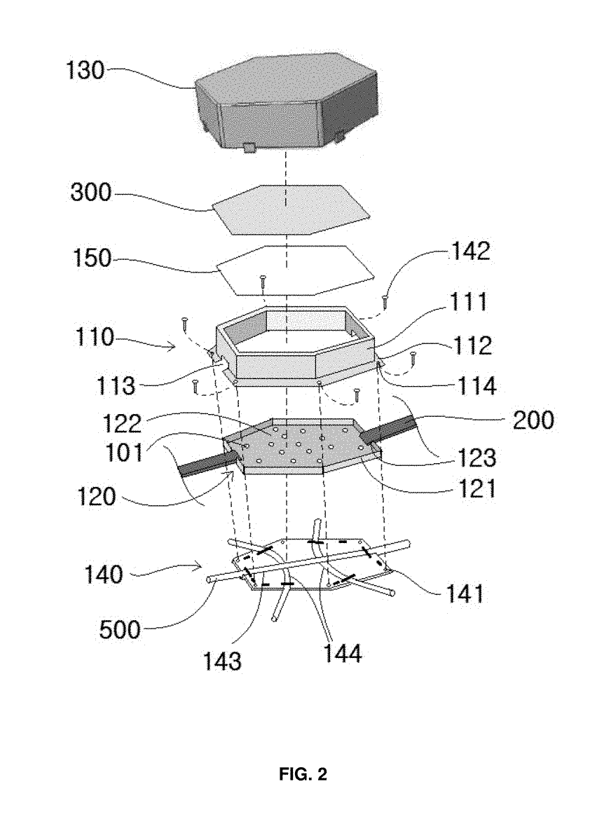

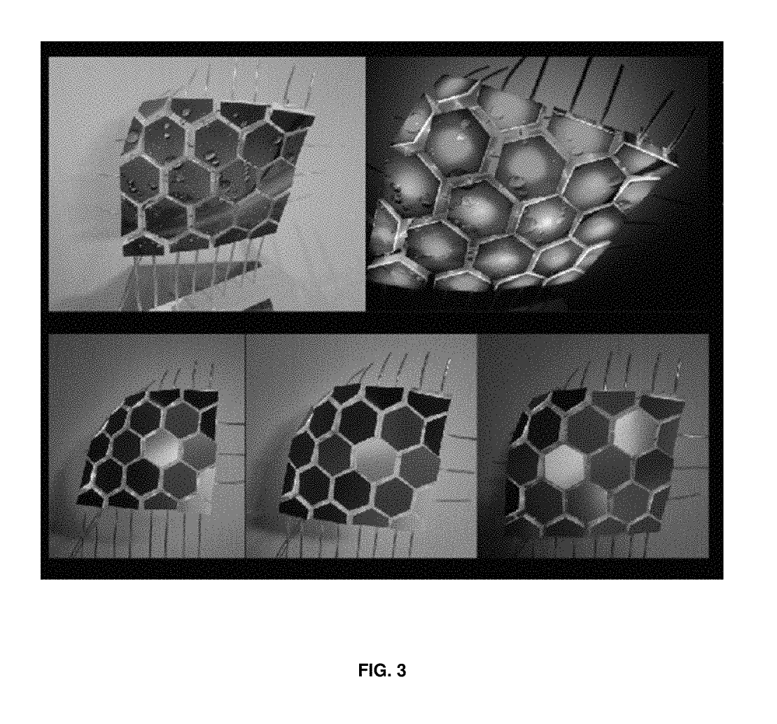

FIG. 1 is a perspective view illustrating a lighting device according to an embodiment of the present disclosure. FIG. 2 is an exploded perspective view describing a lighting device according to an embodiment of the present disclosure. FIG. 3 is an illustration showing an example of a lighting device according to an embodiment of the present disclosure.

In accordance with FIGS. 1-3, a lighting device according to an embodiment of the present invention has a plurality of LED assemblies 100 connected and supported to a plurality of connectors 200 by a plurality of wires 500, wherein the LED assemblies 100 can be extended not only to above and below but also side to side, forming the matrix structure. When the device only includes the connector 200, a plurality of LED assemblies 100 can be connected. Moreover to connectors, when flexible wires 500 are used in combination, more various configurations and structures are possibly formed. Hereafter the wire 500 will be described in detail.

More particularly, the connector 200 according to the present disclosure is made of a material having uniform thickness, such that the connector can connect other LED assemblies 100 each other. Moreover, the wire 500, which has flexibility and durability such as metal wire, also can compile or tie the ends of the LED assemblies, such that the wire can extends enough length.

With the features of such connectors 200 and wires 500, the lighting device according to the present disclosure can be attached various objects. That is, not only to a plane object but also to a curvy structure of a steric object along its surface. That is, when a plurality of LED assemblies 100 are provided in matrix structure and connected each other through a plurality of connectors 200 and wires 500, the assemblies can form various steric structures such as wavy shape, convex shape, concave shape, etc. and create lighting effects accordingly.

A LED assembly 100 according to the present invention may provide not only lighting function using a LED lamp 101 but also aesthetic visual effect with its shape and structure, allowing the LED assembly to offer more dynamic lighting function and to properly attached to a steric object, compared to a conventional LED lighting device which provides only simple LED lamp 101 or LED module connected with flexible power cable.

More specifically, the LED assembly 100 has a main body 110 including LED lamp 101 and a cover 130 which transmits a light generated from LED lamp 101, covering the upper portion of the main body 110. The upper portion of the main body 110 is open upward, wherein the main body 110 has 6 side walls 111 forming sides and a disposition unit 112 having a plurality of first fixing grooves 114 which is bent outward from the side wall 111 and penetrated the side wall 111.

The side wall 111 has at least a first locking groove 113, which functions as passing space when a connector 200 passes through the main body 110 with a second fixing groove of a cover 130 herein after will be described. More particularly, the first locking groove 113 penetrates from the lower part of the side wall 111, along vertical direction of the side wall to a predetermined site of a side (for example, an adjacent site which is lower than the middle of the side).

The disposition unit 112 has a plurality of first fixing grooves 114 which penetrate the main body 110, and has the hexagonal shape bent outward from the side wall 111. The disposition unit 112 and the side wall 111 are described as forming the plane shape, but not limited to the plane shape but can be modified to various steric structures according to an object which a lighting device of the present disclosure is to be attached.

A core body 120 has a LED lamp 101 which provides lighting function. The core body 120 is to be closely inserted into the side wall 111; for this reason, the core body 120 may include a side corresponding to the inside of the side wall 111, a core side wall 121 having a second locking groove 123 corresponding to a first locking groove 113, and a core 122 having lower part side bent from the core side wall and a plurality of LED lamps 101.

The LED lamp 101 is accommodated and supported by a core 122 by a bracket which supports LED lamp 101 or a projection attached on the structure of the LED lamp. The LED lamp 101 is turned on and off by receiving power and control signal through power cable and control cable disposed inside of the core 122, such that ultimately provides lighting function by means of LED light.

As COB (Chip On Board) type, such LED lamp 101 can be manufactured as module type, so it can be coupled with a hollow or accommodate not only a single LED but also a plurality of LEDs based on the simple coupling method.

More particularly, the control of such LED lamp 101 is conducted by a controller 400 which is provided separately; the controller controls not only on/off of the LED lamp 101 in a plurality of LED assemblies 100 but also lighting pattern, such that the plurality of LED assemblies 100 can provide various lighting functions.

Moreover, one end of the core 122 has a core insert unit (not shown), in which a connector 200 inserted through a second locking groove 123 is safely coupled or supported thereat, such that a plurality of connectors 200 can be coupled with the core body 120 through the core insert unit.

That is, the connector 200 is inserted in the core body 120, not being limited to a part of the connector 200 is inserted in the core body 120, but coupling with the core insert unit of core body 120 more tightly. Also, while being inserted, the connector 200 provides additional tie or coupling, such that the connector 200 and the core body 120 can hardly be detached by an external force.

The cover 130 according to present invention covers the upper portion of the main body 110, forming a shape corresponding to the main body 110. The cover 130 provides the light of LED lamp 101 penetration; a surface of such cover 130 is described as plane shape but not limited thereto and can be modified to curvy surface according to the structure of an object which a lighting device of the present invention attached on.

In other words, the effects and functions of an embodiment of the present invention including the configuration herein described are as below;

According to an embodiment of present invention, the LED assembly 100 may include an independent structure which conducts lighting function, but when a plurality of LED assemblies 100 are coupled each other, the LED assemblies 100 can provide various visual effects such as visual effect on a stage, dynamic screen effect, aesthetic visual function, etc. More particularly, when the connector 200 with durability and flexibility is inserted and into the LED assembly 100 and disposed thereto through a first and a second locking groove 113, 123, a plurality of LED assemblies 100 can be connected with each other in the matrix structure of above and below, from side to side and freely expended. Thus, in a place where a large lighting is needed, a plurality of LED assemblies 100 can cover an entire outside wall of a building and provide various visual lighting functions.

Furthermore, when an object which needs lighting is not curvy nor plane, the wire 500 can be added with the connector 200, such that a plurality of LED assemblies 100 can provide a curvy structure by means of the flexibility of the wire 500.

As described herein, a first fixing groove 114 and a second fixing groove corresponding thereto are disposed on a base 140. The base 140 and the main body 110 are coupled with each other when the first fixing groove and the second fixing groove are placed in corresponding manner and coupled with each other by means of the fastener 142 such as screw.

Subsequently, the connector 200 is surrounded by the water proof connector cover 210, and the main body 110 further includes a rubber packing 150 along the inner peripheral thereof to seal the first locking groove from water and dust. Since the LED assembly 100 is installed outer wall or outside of a building, it can be exposed to rain, dust or water with high possibilities. And, since the LED assembly 100 is basically an electronic device, failure or malfunction can be provoked when the inner substrate is exposed to water or dust. Thus, to prevent the case described above, the connector 200 is covered by the connector cover 210, and the rubber packing 150 is placed at the edge to protect the main body from water and dust flows to inside.

The constitution of the wire 500 is described herein as below;

First, the base 140 may include a main slot 143 which is recessed and inserted to cross the center of a pair of sides facing each other, and an auxiliary slot 144 which is recessed in doubled depth of the main slot 143 and inserted to cross the center of the rest of sides at the left and right direction of the main slot 143. The displaying device may include; a wire 500 made of a material having even thickness and flexibility to penetrate at least one of the main slot 143 and the auxiliary slot 144 and to be inserted, such that connects the base and a plurality of LED assemblies.

The main slot 143 and the auxiliary slot 144 are respectively disposed on the base 140, forming a space for the wire 500 to be inserted and fixed. As described above, the LED assembly 100 basically has the hexagonal shape. In other words, the base 140 also has the hexagonal shape accordingly. For example, if the sides are herein referred to 1, 2, 3, 4, 5 and 6 respectively, the main slot 143 inserted to cross a pair of sides is to be cross 1 and 4 or 2 and 5 or 3 and 6. For example, the slot 143 which crosses 2 and 5 is herein referred to main slot 143. Furthermore, the auxiliary slot 144 is recessed and inserted in doubled depth of the main slot 143 to cross the center of the rest of the sides, wherein the auxiliary slot 144 is placed in left and right respectively subject to the main slot 143. In an embodiment of the present invention, the auxiliary slot 143 is formed to cross sides 1 and 3, and 4 and 6 respectively, wherein the shape of the auxiliary slot 144 is similar to character “C”. Additionally, since the auxiliary slot 144 is inserted in doubled depth of main slot 143, the wire 500 inserted in the main slot 143 and the other wire inserted in the auxiliary slot 143 are not overlaid to each other.

As described in FIG. 3, the displaying device according to an example of present invention is basically formed in the hexagonal shape. However, various shapes such as triangle, rectangle or pentagon are also available according to the feature of the object which needs the displaying device.

In addition, the displaying device according to an embodiment of the present invention may further include a wire 500 made of a material having even thickness and flexibility to penetrate at least one of the main slot 143 and the auxiliary slot 144 and to be inserted, such that connects the base 140 and a plurality of LED assemblies. The wire 500 is made of more flexible material than the connector 200 and is able to connect each LED assembly 100 each other even when the LED assemblies 100 are not disposed in parallel manner.

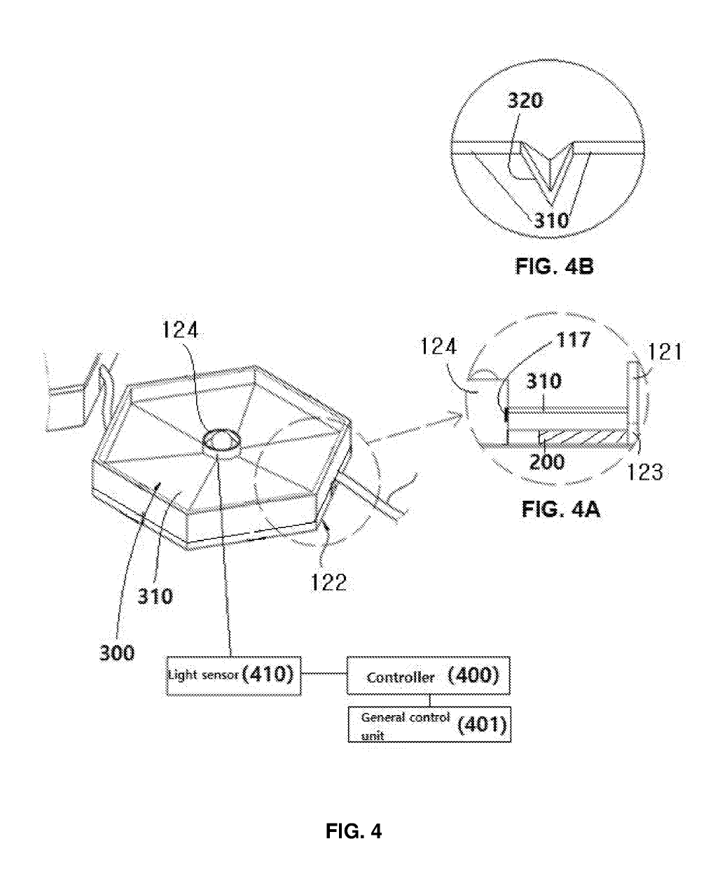

FIG. 4 illustrates an example of an LED assembly, and FIGS. 4A and 4B illustrate a reflective plate disposed inside of the LED assembly.

Inside of the main body 110, a reflective plate 300 is disposed, wherein the reflective plate has a space from the core 122 to cover the core body and reflects lights generated from the LED lamp 101. In other words, the reflective plate 300 is colored in white or has the glossy side.

In reference to FIG. 4A, the center of the core 122 may further include; a core pillar 124 which is extended in height direction, while the core pillar 124 is being disposed on the center of the reflective plate 300 which is extended from a side of core pillar 124 to an internal side of the side wall 111, such that the structure is observed as if another core 122 is departed and disposed at certain interval from the core 122 in upper direction. Such reflective plate 300 can be configured in plane or slightly oblique position. The plane reflective plate 300 is suitable when more light is needed toward front, and the oblique reflective plate 300 is suitable when lighting broader range of space.

The reflective plate 300 can be divided into six identical reflective sides 310 corresponding to the side wall 111. That is, the side wall 111 may include total six sides as described above, such that the reflective sides 310 correspond to each six sides. However, in this case, the side of the core pillar 124 may further include an elevation groove 117 allowing one end of the reflective side 310 to be inserted therein and moved at predetermined range upward and downward. The elevation groove 117 has enough space for the one end of the reflective side 310 to be inserted, and at the same time, the inserted one end can be moved at predetermined range. Thus, users can control the direction of the reflective light by moving the reflective side 310 upward and downward with manual operation through the elevation groove 117.

Furthermore, as described in FIG. 4B, there may also be the extended block unit 320 of which the both ends are respectively attached to different reflective sides 310 when half folded, such that the sides can contract and relax from side to side, wherein the extended block unit 320 is attached between a reflective side 310 and another reflective side 310.

The extended block unit 320 is preferably made of the same material as the reflective side 310 for easily contractible/relaxing. Such extended block unit 320 does not allow empty space between a reflective side 310 and another reflective side 310, such that the extended block unit 320 prevents dark shadow when a light is reflected, thus the uniformly reflected light of the displaying device can be observed from outside.

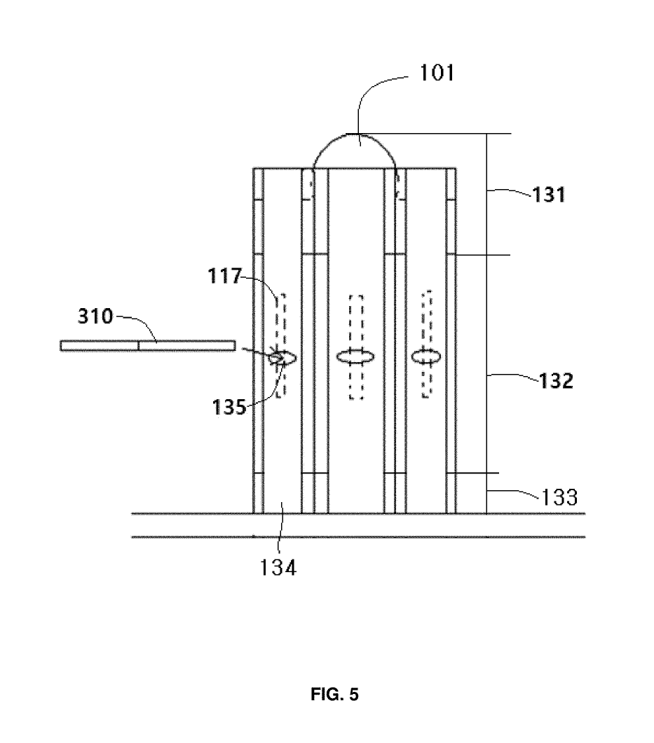

FIG. 5 is a side view illustrating a core configuration according to an embodiment of the present disclosure.

A detailed configuration of the core pillar 124 is herein described as below;

The core pillar 124 may include; a lamp unit 131 having at least one LED lamp 101; a core supporter 132 having a plurality of elevation grooves 117 on a side and supporting the lamp unit 131; a coupling unit 133 coupled with the core 122 disposed on an end of core supporter unit 132; and a band-shaped fixing band 134 which fixes outside peripheral of successive layer consisting of the lamp unit 131, the core supporter unit 132 and the coupling unit 133, wherein the fixing band 134 has a band groove 135 disposed at the corresponding site of the elevation groove 117, such that one end of the reflective side 310 can penetrate the band groove 135 to be inserted into the elevation groove 117.

That is, the lamp unit 131 including LED lamp is disposed at the top portion of the core pillar 124. The lamp unit 131 may include the all elements of LED lamp 101, being disposed at the top of the core pillar 124 and generating light inside of the main body 110. In addition, the core supporter unit 132 is disposed at the lower part of the lamp unit 131, supporting the lamp unit 131, wherein the core supporter unit 132 has a plurality of elevation grooves 117 on one side. The core supporter unit 132 functions as a kind of pillar, supporting the lamp unit 131 at the upper portion and the coupling unit 133 at the lower part. Since the coupling unit 133 is the coupled part with the core 122, a configuration for heat sinking is applicable, which a heat generated from the lamp unit 131 can be discharged to the core 122 through the coupling unit 133.

In addition, a band-shaped fixing band 134 is included in the configuration, wherein the fixing band 134 surrounds an outer peripheral of a layer successively consisting of the lamp unit 131, the core supporter unit 132 and the coupling unit 133. The fixing band 134 alone can fix the layer successively consisting of lamp unit 131, the core supporter unit 132 and the coupling unit 133. However, it is preferable to use three pieces of fixing band 134 and to allow each band to face the six side walls 111.

At the same time, a band groove 135 is formed at the corresponding site to the elevation groove 117 on the fixing band 134. One end of reflective side 310 is inserted to the elevation groove 117 and moves up and down, wherein the reflective side 310 passes through the band groove 135 before being inserted to the elevation groove 117. Since the elevation groove 117 secures a space for the reflective side 310 to move up and down, a light impact may allow the reflective side 310 to move up and down or to deviate from the elevation groove 117. However, the unnecessary moving and deviation can be prevented when the reflective side 310 passes through the band groove 135 and is inserted into the elevation groove 117. To prevent the unnecessary moving and deviation, the band groove 135 is formed in exactly corresponding size of the one end of the reflective side 310 or slightly smaller size thereof, which allows the reflective side 310 to be inserted to band groove 135. Thus, the reflective side 310 is hardly deviated from the band groove 135 and the elevation groove 117 accordingly.

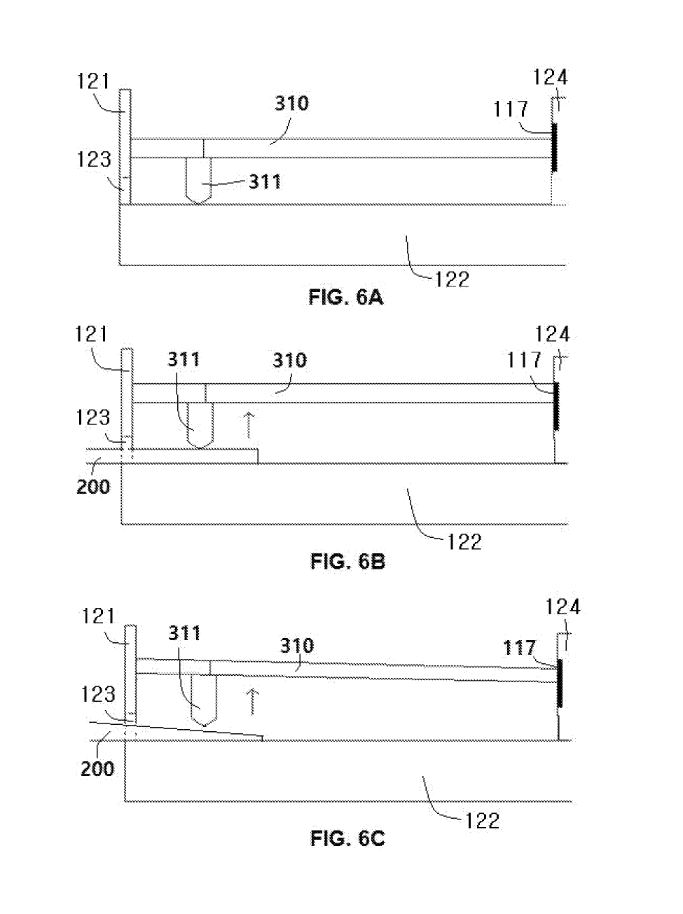

FIGS. 6A-6C are end views describing the elevation projection 311 disposed on the reflective side 310 according to an embodiment of the present disclosure. In reference to FIGS. 6A-6C, a configuration for controlling a reflective angle of reflective side 310 is described as below;

The back side of the reflective side 310 may include; an elevation projection 311 protrusively extended to one side of the core 122, wherein the connector 200 penetrates through the first locking groove 113 and the second locking groove 123, and then is inserted moving such elevation projection, such that the connector 200 raises the reflective side 310 as much as the thickness of the connector 200.

The elevation projection 311 can be applied to any shape as long as it has no edge. As described above, the connector 200 is inserted through the first locking groove 113 and the second locking groove 123, having uniform thickness. That is, after passing through the first locking groove 113 and the second locking groove 123, the connector meats the elevation projection 311, and a space is formed for the connector 200 to be moved by raising the elevation projection 311 toward the upper portion. The reflective side 310 is also raised upward by the upwardly raised elevation projection 311. The following is the result of the elevation according to a size or shape of elevation groove 117;

First, when the size of the elevation groove 117 can support the vertical movement of elevation projection 311 due to the thickness of the connector 200, the elevation side 310 allows the connector to be inserted and move upward to the upper portion in parallel manner. On the other hand, when the size of the elevation groove 117 is not enough to support the vertical movement of elevation projection 311 due to the thickness of the connector 200, the one end of the reflective side 310 is protruded while another end is being inserted into the elevation groove 117. In other words, the reflective side 310 is disposed in the oblique position. That is, by using this feature, the thickness of the inserted connector 200 can be controlled, allowing the reflective side 310 of six directions to have different reflection angle respectively.

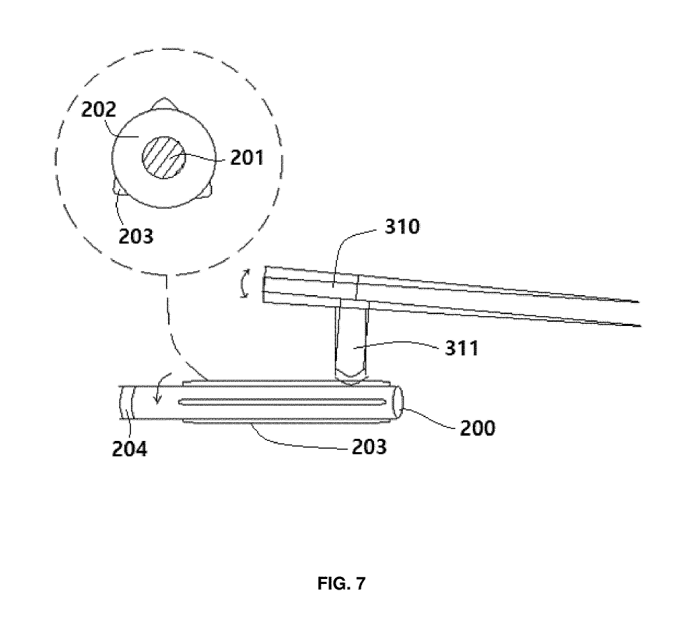

FIG. 7 is a perspective view describing the connector 200 structure according to an embodiment of present disclosure.

The connector 200 may include a rotary shaft 201, a shaft cover 202 which is inserted in the rotary shaft and rotates, and at least one rotary projection 203 which is protruded on a surface of the shaft cover 202. In correspondence with the described above, a side of the reflective plate 300 may further include; a tooth plate 330 having teeth which are uniformly spaced and protruded, wherein the tooth plate 330 is vertically bent from the reflective plate 300. Also, a side of the core pillar 124 may further include a supporter shaft 340 extended to the tooth plate 330 and a spherical gear 341 which is connected to be rotated at one end of the supporter shaft 340 and transmits the rotary power generated according to the raising and lowering movement of the tooth plate 330 between the tooth plate and the other tooth plate 330 disposed on the opposite side, wherein the tooth plate 330 is to be raised and lowered correspondingly with other tooth plate 330 disposed on a side of other reflective plate 300 through the spherical gear 341.

The connector 200 may further include; a rotary shaft 201; a shaft cover 202 which is inserted in the rotary shaft and rotates; and at least one rotary projection 203 which is protruded on a surface of the shaft cover. The shape of the rotary projection 203 is not particularly limited. However, since the rotary projection 203 directly raises up the reflective side 310 or the elevation projection 311 attached on the reflective side 310 according to the rotation of the shaft cover 202, any shape which is not excessively protruded or sharp edge is applicable. An oblique side of pinwheel shape, which is proper for rotation direction, is preferable. In addition, the shaft cover 202 and the rotary projection 203 are not necessarily disposed to every connector 200, and can be attached to a part corresponded to the elevation projection 311.

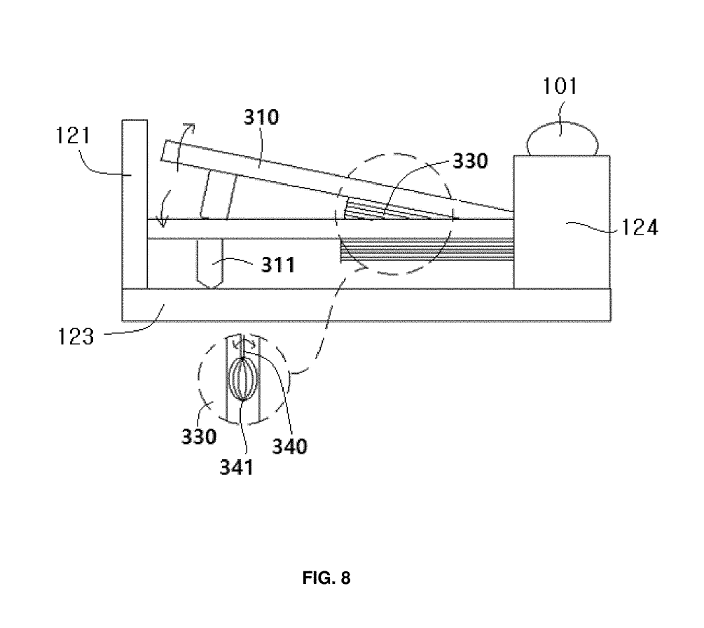

FIG. 8 is a perspective view illustrating the configuration of tooth plate 330 on the reflective side 310 according to an embodiment of the present disclosure.

The height or inclination of the reflective plate 300 can be controlled by the rotation of the shaft cover 202 through the configuration of rotary projection 203 described above. However, such control has a limitation to control all the six reflective plates 300 at the same time. To solve the limitation, a side of the reflective plate 300 may further include the tooth plate 330 vertically bent from the reflective plate 300 and having protruded teeth at regular intervals. The tooth plate 330 is to face another tooth plate 330 of another reflective plate 300 on the opposite side. At the same time, the supporter shaft 340 which is extended from the side of the core 122 and the spherical gear 341 which is connected to rotate at one end of the supporter shaft 340 are disposed between the pair of facing tooth plates 330. That is, tooth plate 330, spherical gear 341 and tooth plate 330 are closely configured in that order.

In addition, the tooth plate 330 moves up and down, allowing the connected spherical gear 341 to rotate and generate rotatory force. The rotatory force is transmitted to the geared facing tooth plate 330 and operates vertical movement of the facing tooth plate 330. When at least of one reflective plate 300 is controlled in this manner, the rest 5 reflective plates 300 geared to the tooth plate 330 can be controlled at the same time according to the feature of teeth. The feature of teeth suggests two method for controlling the vertical movement of tooth plate 330; first, in a zigzag manner, which one tooth plate 330 is raised, the adjacent tooth plate 330 is lowered; second, when one tooth plate 330 is raised, the other tooth plates 330 are raised all together, and vice versa. Without the need to control each tooth plates 330 respectively one by one, the tooth plates are vertically moved when only one tooth plate 300 is controlled, and the rest of the tooth plates 300 need only a little adjustment to ultimately control the reflective plate 300.

In addition, although the drawings of the present invention do not show, an optional operation shaft can be added between one assembly 100 and another assembly 100, wherein the shaft transmits the rotatory force of movement of one tooth plate 330 to another tooth plate 330 corresponding to a movement of a tooth plate 330. Also, the operation shaft can be included in some connectors 200 instead of the rotary shaft 201 without a separate configuration.

Additionally, a rotation module 204 can be added to at least one connector 200, wherein the module 204 is inserted to the rotary shaft 201 and provides rotary force to rotate the shaft cover 202. The rotation module 204 has a similar configuration as motor which provides rotatory force; the shaft cover 202 is rotated by the rotatory force of the rotation module 204. The methods for providing rotatory force may include the followings: rotating the rotary shaft 201 itself, such that the rotary shaft 201 and the shaft cover 202 can be rotated together, and rotating only the shaft cover 202 at one end of the shaft cover 202.

When the shaft cover 202 automatically is rotated as described above, the rotary projection 203 formed at the shaft cover 202 is rotated together, such that one part with the rotary projection 203 and the other part without the rotary projection 203 are continuously disposed at the lower part of the reflective side 310, allowing the reflective side 310 to continuously move up and down such as a wave. That is, the LED assemblies 100 look continuously changing in various patterns when observed from outside due to the reflection angle or intensity of reflection of the reflective side 310 can be continuously changed by the configuration described above.

Lastly, the core pillar 124 may further include a light sensor 410 which measures an intensity of light reflected from the LED lamp 101 of the six reflective plates 310 and a controller 400 having an elevation control of the reflective side 310 by operating the rotation module 204 according to the measured intensity of light and a general control unit 401 which conducts flashing control of pattern and intensity of light according to whether or not the LED lamp 101 is on.

The light sensor 410 measures the intensity of each light from six reflective sides 310 which reflect light from the LED lamp 101, and the controller 400 ultimately controls the rotation module 204 according to the measured intensity of light to control the level of elevation or inclination of each reflective side 310. First, a previously saved value of the maximum intensity of light or a value of maximum intensity of light entered in real-time by a user is saved at the controller 400. The value of maximum intensity of light is compared with the intensity of light of the reflective side 310 measured by the light sensor 410. When the measured value of intensity of light is less than the maximum value, the reflective plate 300 is moved toward the LED lamp 101, which allows the most vertical inclination to achieve the more similar value as the demanded maximum value of intensity of light. When the measured value of intensity of light is more than the maximum value, the reflective plate 300 is moved and departed from the LED lamp 101, which allows the most horizontal inclination to achieve the more similar value as the demanded maximum value of intensity of light.

Additionally, whether the LED lamp 101 is on or off can be also controlled. Technically by on/off control of the LED lamp 101, controlling a required radiation or intensity of light is possible. Thus, a user may maintain the desired radiation or amount of light by controlling elevation control and on/off control in the general control unit 401 of the controller 400. According to the configuration herein described, a functionality LED assembly-linked displaying device provides various lighting effects with little or no power.

As herein described, although the configuration and the functions according to an exemplary embodiment of functionality LED assembly-linked displaying device according to the present invention have been described in the description and drawings, the embodiment is an example and is not limited to the description and drawings, and various modifications and substitutions will be possible without departing from the scope and spirit of the invention.

Reference Numerals

| | |
|---|---|
| 100: LED assembly | 101: LED lamp |
| 110: Main body | 111: Side wall |
| 112: Disposition unit | 113: First locking groove |
| 114: First fixing groove | 117: Elevation groove |
| 120: Core body | 121: Core side wall unit |
| 122: Core | 123: Second locking groove |
| 124: Core pillar | 130: Cover |
| 131: Lamp unit | 132: Core supporter unit |
| 133: Coupling unit | 134: Fixing band |
| 135: Band groove | 140: Base |
| 141: second fixing groove | 142: Fastener |
| 143: Main slot | 144: Auxiliary slot |
| 150: Rubber packing | 200: Connector |
| 201: Rotary shaft | 202: Shaft cover |
| 203: Rotary projection | 204: Rotation module |
| 210: Connector cover | 300: Reflective plate |
| 310: Reflective side | 311: Elevation projection |
| 320: Extension block unit | 330: Tooth plate |
| 340: Supporter shaft | 341: Spherical gear |
| 400: Controller | 401: General control unit |
| 410: Light sensor | 500: Wire |

What is claimed is:

1. A functionality LED assembly-linked displaying device, wherein adjacent LED assemblies are connected each other through connectors comprising;
a side wall having six sides and at least one first locking groove,
a main body having a disposition unit bent from the side wall toward outside with a plurality of first fixing grooves;
a core side wall, having sides in close contact with the side wall, with a core side having second locking groove disposed at a site corresponding to the first locking groove;
a core body having lower part side bent from the core side wall and a core having a plurality of LED lamps;
a cover having a cover side, in which the light from the LED lamp penetrates the cover side while the cover side is covering the top side of the main body;
an LED assembly having a base coupled by a fastener connecting a second fixing groove at corresponding site to a first fixing groove and supporting the lower part of the main body when the core body is inserted in the main body; and
a connector to be penetrating the first and the second locking grooves and inserted in the core body through the LED assembly, made of a material having uniform thickness.

2. The displaying device according to claim 1, further comprising:
a water proof connector cover covering the surface of the connector; and
a rubber packing of the inside of the main body in close contact along an inner peripheral to seal the first locking groove from water and dust.

3. The displaying device according to claim 1, wherein
the base further comprises:
a main slot which is recessed and inserted to cross the center of a pair of sides; and
an auxiliary slot which is recessed and inserted in doubled depth of the main slot to cross the center of rest of sides respectively disposed in the left and right direction of the main slot;
wherein the displaying device further comprises:
a wire made of a material having uniform thickness and flexibility to penetrate at least one of the main slot and the auxiliary slot and to be inserted, such that connects the base to a plurality of LED assemblies.

4. The displaying device according to claim 1, further comprising a reflective plate having a space from the core to cover the core and reflecting light generated from the LED lamp.

5. The displaying device according to claim 4, further comprising:
a core pillar extended toward height direction in the center part of the core body;
a reflective plate divided into six identical reflective sides corresponding to the side wall; and
an elevation groove is formed on a side of the core pillar, in which one end of the reflective side is inserted in the core pillar, such that the reflective plate is to be moved within predetermined range.

6. The displaying device according to claim 5,
an extended block unit between the reflective side and an adjacent reflective side thereof, the extended block unit disposed on both sides of reflective plates respectively when half folded, such that the sides can be contracted and relaxed from side to side.

7. The displaying device according to claim 5, wherein the core pillar comprises:
a lamp unit having at least one LED lamp;
a core supporter having a plurality of elevation grooves on a side and supporting the lamp unit;
a coupling unit coupled with the core body disposed on an end of core supporter; and
a band-shaped fixing band which fixes outer peripheral of successive layer of the lamp unit, the core supporter and the coupling unit,
wherein the fixing band has a band groove disposed at the corresponding site of the elevation groove, such that one end of the reflective plate can penetrate the band groove and be inserted into the elevation groove.

8. The displaying device according to claim 5,
further comprising, on the back side of the reflective plate, an elevation projection protrusively extended to one side of the core body,
wherein the connector penetrates through the first locking groove and the second locking groove, such that the connector raises the reflective plate as much as the thickness of the connector.

9. The displaying device according to claim 8, wherein the connector further comprises:
a rotary shaft;
a shaft cover which is inserted in the rotary shaft and rotates;
at least one rotary projection which is protruded on a surface of the shaft cover;
and wherein at least one of the connector comprises:
a rotary module which is inserted to the rotary shaft and provides power to rotate the shaft cover.

10. The displaying device according to claim 9, further comprising:
a tooth plate on a side of the reflective plate, the tooth plate having teeth which are spaced in uniform intervals and protruded, wherein the tooth plate is vertically bent from the reflective plate on a side of the reflective plate;
a supporter shaft on a side of the core pillar, the supporter shaft extended to the tooth plate;
and a spherical gear which is connected to be rotated at one end of the supporter shaft and transmits the rotary power generated according to the raising and lowering movement of the tooth plate between the tooth plate and the other tooth plate disposed on the opposite side,
wherein the tooth plate is to be raised and lowered accordingly with other tooth plate disposed on a side of other reflective plate through the spherical gear.

11. The displaying device according to claim 9, wherein the core pillar further comprises:
a light sensor which measures an intensity of light reflected from the LED lamps of the six reflective plates; and
a controller having an elevation control of the reflective side by operating the rotary module according to the measured intensity of light and a general control unit which conducts flashing control of pattern and intensity of light according to whether or not the LED lamp is on.
